(19) United States
(12) Patent Application Publication
(10) Pub. No.: US 2004/0149532 A1
(43) Pub. Date: Aug. 5, 2004

(54) Vibration absorber

(76) Inventor: Wolfgang Beigang, Ruppichteroth (DE)

Correspondence Address: Robert P. Renke, Suite 250, 28333 Telegraph Road, Southfield, MI, 48034, US

(21) Appl. No.: 10/723,569

(22) Filed: Nov. 26, 2003

(30) Foreign Application Priority Data
Nov. 26, 2002 (DE) 102 55 237.1

(51) Int. Cl. F16F 7/10

(52) U.S. Cl. 188/379

(57) ABSTRACT

A vibration absorber for attaching to a rotatable driveshaft, such as a driveshaft of a motor vehicle. The vibration absorber includes an annular-cylindrical mass member arranged at a radial distance from the driveshaft, a plurality of circumferentially spaced elastic supporting elements shaped to be positioned on the driveshaft, which are firmly connected to the mass member and which, relative to the mass member, extend radially inwardly, and an elastic fixing sleeve shaped to be positioned on the driveshaft. At is one end, the fixing sleeve is firmly connected to the mass member and includes a cylindrical collar portion with a seat face.

### BACKGROUND OF THE INVENTION

The invention relates to a vibration absorber for a rotatable driveshaft such as a sideshaft of a motor vehicle. More particularly, the device serves to absorb bending vibrations in rotatable driveshafts.

### BACKGROUND OF THE INVENTION

Motor vehicle drivelines typically include rotatable propeller shafts and sideshafts. Sideshafts extend from the axle drive to the driven wheels. For example, they connect the output ends of the rear axle differential with the driven wheel hubs of the wheels. Such rotatable driveshafts in the drivelines of motor vehicles can generate, at certain rotational speeds, undesirable vibrations which result from unbalanced distribution of masses. These undesirable vibrations themselves often generate bending and torsional forces inside the driveshafts during rotation.

DE 190 38 290 C2 proposes a vibration damping device for absorbing rotational and bending vibrations in a rotatable driveshaft. The vibration damping device comprises an annular-cylindrical mass member to which there is attached a plurality of uniformly circumferentially distributed, radially inwardly extending elastic supporting elements which extend axially parallel relative to one another. By means of the supporting elements, the rotation vibration damping device can be slid on to a driveshaft, wherein the supporting elements are subject to a radial compressive stress and hold the mass member concentrically relative to the driveshaft. The vibration damping device is not securely fixed on the driveshaft, neither axially nor in the direction of rotation.

U.S. Pat. No. 5,056,763 shows a dynamic vibration damping device for damping rotational and bending vibrations in motor vehicle driveshafts. The vibration damping device comprises an annular-cylindrical mass member and two elastic sleeves which are arranged at the ends of same, whose diameter is smaller than that of the mass member and which are designed for being positioned on the driveshaft. The mass member is integrally formed into an elastic sleeve to which there are attached the elastic collars. The inner diameter of the sleeve is greater than the outer diameter of the associated driveshaft, so that an annular chamber is formed between the components. The collars are closed in the circumferential direction, so that the annular chamber is not ventilated, which results in the risk of corrosion for the driveshaft within the annular chamber. Also, changing the characteristics of the rotational vibration damping device is problematical.

From JP 02-221731 A there is known a vibration absorber which comprises an annular-cylindrical mass member which, at its two axial ends, is held on the shaft via annular-cylindrical collars. As a result, there is formed a hermetically sealed inner chamber between the vibration absorber and a driveshaft, in which chamber there may be enclosed humidity which can generate corrosion at the driveshaft.

JP 08-177976 A proposes a vibration absorber which comprises an annular-cylindrical mass member and a fixing collar which extends over a greater axial length than the mass member and which is positioned on a driveshaft with surface contact. The mass member and the fixing collar are elastically connected to one another by circumferentially distributed supporting elements. The large surface of the collar can easily trap humidity which can then generate corrosion at the driveshaft.

Thus, there exists a need for ain improved driveshaft vibration absorber with easily modified absorbing characteristics, that can be firmly fixed to the driveshaft, and that is not susceptible to forming corrosion.

### SUMMARY OF THE INVENTION

The present invention provides a vibration absorber for attaching to a rotatable driveshaft, such as a sideshaft of a motor vehicle, whose characteristics can easily be modified and which can be axially firmly applied on to the driveshaft. The vibration absorber also avoids the formation of corrosion on the driveshaft.

The vibration absorber for attaching to a rotatable driveshaft includes an annular-cylindrical mass member arranged at a radial distance from the driveshaft, a plurality of circumferentially spaced supporting elements which comprise an elastic material, which are shaped to be positioned on the driveshaft, which are firmly connected to the mass member and which, relative thereto, extend radially inwardly, as well as a fixing sleeve of elastic material, which is shaped to be positioned on the driveshaft and which, at its one end, is connected to the mass member. In one embodiment, the fixing sleeve, starting from its end connected to the mass member, comprises a circumferentially closed, radially tapered sleeve portion. Alternatively, the radially tapered sleeve portion can also comprise through-apertures, so that at the sleeve portion, the annular chamber between the mass member and the driveshaft is connected to the environment. In another concept, the fixing sleeve, at its end opposed to the mass member, comprises a cylindrical collar portion with a seat face.

The present vibration absorber is advantageous in that the elastic supporting members can be readily modified, while leaving the design otherwise unchanged, to easily adapt the absorber to different requirements. With the help of the simple elastic fixing sleeve, the vibration absorber can be axially firmly connected to the driveshaft, so that it retains its desired position even when the driveshaft vibrates. By designing the supporting elements in such a way that they are arranged at the mass member around the circumference while being arranged at a distance from one another, it is ensured that the annular chamber formed between the driveshaft and the mass member is well ventilated. Any humidity which enters the annular chamber and which can lead to corrosion, especially in connection with salt, can evaporate, thus reducing the risk of corrosion at the driveshaft.

According to one embodiment, the supporting elements, on the radial outside, are connected to one another to form an annular member. Indeed, the supporting elements and the fixing sleeve can be integrally connected to one another to form one single annular member. The mass member, in the form of an insert, can be integrally formed into the annular elastic member.

According to another embodiment, the cylindrical mass member comprises metal, such as steel. To keep production costs low, the mass member can be bent out of plate metal so as to acquire a round shape and it can comprise a continuous longitudinal slot. It is also possible to produce the cylindrical mass member from two or more partially cylindrical elements, which can be integrally formed into the elastic member.

According to a further embodiment of the invention, the tapered sleeve portion of the fixing sleeve extends so as to be conical from the mass member to the cylindrical collar portion. The wall thickness in the tapered sleeve portion preferably decreases from the mass member to the cylindrical collar portion. Alternatively, the wall thickness in the tapered sleeve portion can be constant from the mass member to the cylindrical collar portion, or it can increase.

According to a still another embodiment, the cylindrical collar portion of the fixing sleeve, on the radial outside, comprises a continuous annular groove for the purpose of accommodating a clamp band. An additional clamp band can be used for securing the vibration absorber on the driveshaft.

According to another embodiment, the supporting elements comprise only a fraction of the axial length of the mass member. This embodiment permits a greater freedom of movement of the mass member around the central plane of the supporting elements if the fixing sleeve is relatively resilient. The supporting elements constitute the spring and damper units of the vibration absorber, which units, in this way, can have a relatively elastic design.

To ensure that the mass member is uniformly supported along its length and is coaxially fixed at the driveshaft, the supporting elements are connected to the mass member at the end which is axially opposed to the fixing sleeve. In a first embodiment, the supporting elements can be arranged axially within the length of the mass member at an axial distance from the end of the mass member. In an alternative embodiment, the supporting elements can be arranged, at least partially, axially outside the length of the mass member, for example, so as to adjoin the end of the mass member.

According to a further embodiment, the supporting elements have the same cross-sectional shape relative to one another, for example, a generally rectangular cross-sectional shape. In an alternative embodiment, the supporting elements can also be tapered from the radial outside to the radial inside.

The supporting elements should be uniformly circumferentially distributed.

In addition, the material for the elastic member can be either rubber or another permanently elastic material with good internal damping characteristics.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

Two embodiments will be explained below with reference to the following drawings wherein:

FIG. 1 is a longitudinal section through a vibration absorber in a first embodiment secured to a driveshaft.

FIG. 2 shows the vibration absorber according to FIG. 1 along sectional line B-B.

FIG. 3 is a longitudinal section through a vibration absorber in a second embodiment secured to a driveshaft.

FIG. 4 shows the vibration absorber according to FIG. 3 along sectional line B-B.

FIG. 5 shows the vibration absorber according to FIG. 3 along sectional line C-C.

### DETAILED DESCRIPTION OF THE DRAWINGS

While the present invention is described with regard to a vibration absorber for a rotatable vehicle driveshaft, the present invention may be adapted to be used in connection with any rotational shaft where it is desirable to reduce bending vibrations. Thus, the constructed embodiments described below are intend as examples and are not meant to be limiting.

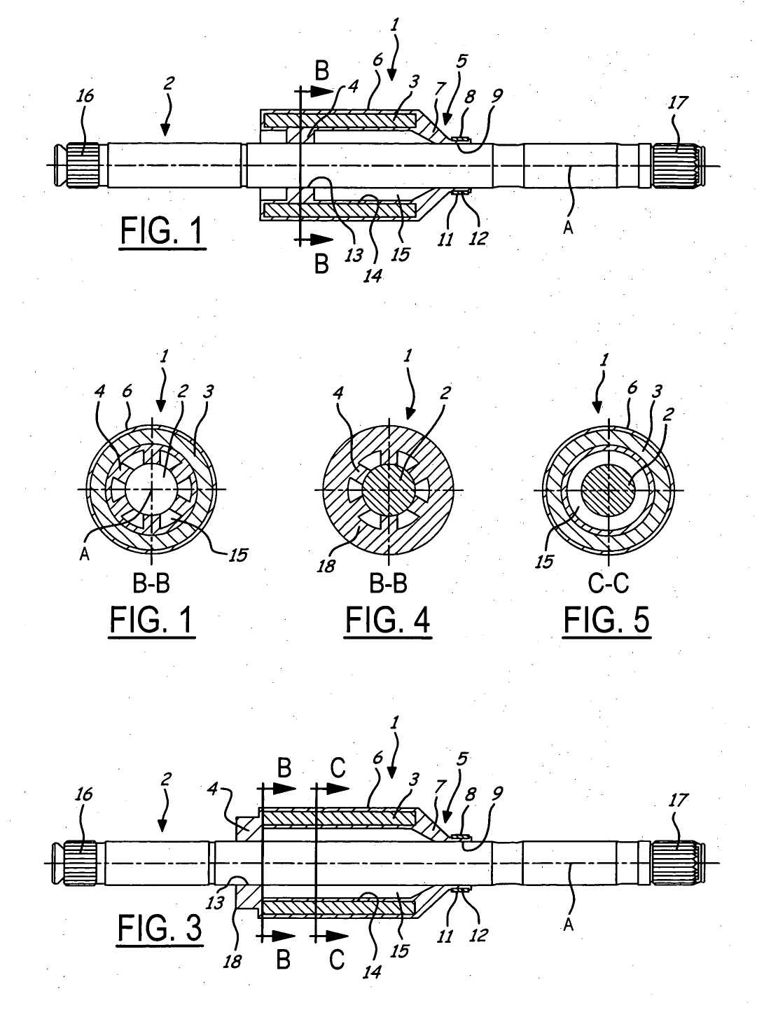

Below, FIGS. 1 to 5 will initially be described jointly. They show an inventive vibration absorber 1 which is secured to a driveshaft 2. The driveshaft 2 serves to transmit torque in the driveline of a motor vehicle. For this purpose, the driveshaft, at its end, comprises shaft toothings 16, 17 to each of which an inner joint part (not illustrated) of a constant velocity universal joint can be attached.

The vibration absorber 1 comprises an annular-cylindrical mass member 3 which is integrally formed into an elastic member 6 which is arranged around the longitudinal axis A so as to extend coaxially relative to the driveshaft 2. The annular-cylindrical mass member 3 has an inner diameter which is greater than the outer diameter of the driveshaft, so that there is formed an annular chamber 15 between the driveshaft 2 and the mass member 3.

For securing the mass member 1 to the driveshaft 2, the elastic member 6 of the vibration absorber 1 comprises supporting elements 4 associated with a first end of the mass member 3 and, axially opposite thereto, a fixing sleeve 5 associated with a second end of the mass member 3. The mass member 3 is completely embeddedly held in the elastic member 6 so as to be fixed, and the elastic member 6 is designed to be integral with the supporting elements 4 and the fixing sleeve 5.

The cylindrical mass member 3 comprises metal such as steel. The mass member 3 can be formed out of plate metal into a round shape and it can comprise a continuous longitudinal slot. It can also be formed out of two or more partially cylindrical elements which can be formed into the elastic member 6.

The fixing sleeve 5 comprises a radially tapered sleeve portion 7 which starts from the second end of the mass member 3 and extends towards the driveshaft 2 and which is shaped so as to be conical and comprises a decreasing wall thickness. The radially tapered sleeve portion 7 can include through-apertures so that, at the sleeve portion 7, the annular chamber 15 is in fluid communication with the environment. The fixing sleeve 5 also comprises a cylindrical collar portion 8 which adjoins the radially tapered sleeve portion 7. The wall thickness in the tapered or conical sleeve portion 7 decreases from the mass member 6 to the cylindrical collar portion 8, although it could be constant or increasing depending upon the desired properties of the absorber. The cylindrical collar portion 8 is arranged so as to axially adjoin the mass member 3 and, on is radial inside, comprises a seat face 9 for accommodating the driveshaft 2. In the unmounted condition of the vibration absorber, the inner diameter of the cylindrical collar portion 8 is smaller than the outer diameter of the driveshaft, so that the vibration absorber is axially fixed on the driveshaft 2 via its fixing sleeve 5 by means of a press fit. Furthermore, on the radial outside at the cylindrical collar portion 8, there is provided an annular groove 11 which is engaged by a clamp band 12 or tensioning strips, thus axially fixing the vibration absorber 1 on the driveshaft 2. To achieve a particularly strong axial fixing, the driveshaft 1, in the region of the seat face 9 of the fixing sleeve 5, can comprise a continuous annular groove into which the cylindrical collar portion 8 is pressed by means of the clamp band 12. This is not the case here.

Axially opposite the fixing sleeve 5, there are arranged the supporting elements 4 which, in the embodiments according to FIGS. 1 and 2, are positioned axially within the length of the mass member and radially inside the inner diameter of the mass member 3 while keeping the latter, coaxially, at a distance from the driveshaft. The supporting elements 4 are provided in the form of ribs which are arranged parallel relative to one another, which extend over a partial axial region of the length of the mass member 3 and which, while starting from the inner face 14 of the mass member 3, are directed radially inwardly. As is particularly obvious from FIG. 2, the supporting elements 4 are uniformly distributed around the circumference and are at equal distances from one another. The supporting elements comprise a rectangular cross-section and, on their radial insides, each comprise a contact face 13 by means of which, in the mounted condition of the vibration absorber 1, they are supported on the driveshaft 2. The axial distance of the supporting elements 4 from the end of the mass member 3 approximately corresponds to the axial extension of the supporting elements 4.

In the embodiment according to FIGS. 3 to 5, the supporting elements 5 are arranged axially opposite the fixing sleeve 5; they are positioned radially inside the inner diameter of the mass member 3 and hold same coaxially at a distance from the driveshaft. The supporting elements 4 are provided in the form of ribs which are arranged parallel relative to one another, which extend axially outside the length of the mass member 3 and which are connected by an outer cylindrical member 18 made out of the same material. The supporting elements 4, starting from the cylindrical member 18, are directed individually radially inwardly. As is particularly obvious in FIG. 5, the supporting elements 4 are uniformly circumferentially distributed and are arranged at equal distances from one another. The supporting elements 4 comprise a rectangular cross-section and, on their radial insides, each comprise a contact face 13 by means of which, in the mounted condition of the vibration absorber 1, they are supported on the driveshaft 2.

Referring to FIGS. 1 to 5, two diametrically opposed supporting elements 4, by means of their contact faces 13, define an inner diameter, and in the unmounted condition of the vibration absorber 1, the inner diameter is smaller than the outer diameter of the driveshaft 2. In this way, a press fit is achieved between the totality of the circumferentially distributed supporting elements 4 and the driveshaft 2, so that the mass member 3, in the mounted condition, is axially and radially firmly held on the driveshaft 2 even in the region of its end located opposite the fixing sleeve 5. In the mounted condition, the contact faces 13 are in contact with the driveshaft 2, wherein the supporting elements 4 which are produced integrally with the elastic member 6 from an elastic material are able to accommodate pressure forces of different values. More particularly, the elastic material can be rubber or rubber mixtures.

While the invention has been described in connection with several embodiments, it should be understood that the invention is not limited to those embodiments. Rather, the invention covers all alternatives, modifications, and equivalents as may be included in the spirit and scope of the appended claims.

What is claimed is:

1. A vibration absorber for attaching to a rotatable driveshaft comprising an annular-cylindrical mass member (3) arranged at a radial distance from the driveshaft; a plurality of circumferentially spaced elastic supporting elements (4) shaped to be positioned on the driveshaft, which are firmly connected to the mass member (3) and which, relative thereto, extend radially inwardly; and an elastic fixing sleeve (5) shaped to be positioned on the driveshaft and which, at its one end, is connected to the mass member (3).

2. A vibration absorber according to claim 1, wherein the fixing sleeve (5), starting from its end connected to the mass member (3), comprises a circumferentially closed, radially tapered sleeve portion (7).

3. A vibration absorber according to claim 2, wherein the fixing sleeve (5), at its end opposing the mass member (3), comprises a cylindrical collar portion (8) with a seat face (9).

4. A vibration absorber according to claim 1, wherein the supporting elements (4), on their radial outside, are connected to one another to form an annular elastic member (6) with one another.

5. A vibration absorber according to claim 1, wherein the supporting elements (4) and the fixing sleeve (5) are integrally connected to one another in an annular elastic member (6).

6. A vibration absorber according to claim 5, wherein the mass member (3), in the form of an insert, is integrally formed in the annular elastic member (6) with the supporting elements (4) and the fixing sleeve (5).

7. A vibration absorber according to claim 1, wherein the cylindrical mass member (3) is metal.

8. A vibration absorber according to claim 7, wherein the cylindrical mass member is formed out of plate metal so as to be round.

9. A vibration absorber according to claim 3, wherein the sleeve portion (7) of the fixing sleeve (5) is shaped to be conical from the mass member (3) to the collar portion (8).

10. A vibration absorber according to claim 9, wherein the wall thickness in the sleeve portion (7) decreases from the mass member (3) to the collar portion (8).

11. A vibration absorber according to claim 9, wherein the wall thickness in the sleeve portion (7) is constant from the mass member (3) to the collar portion (8).

12. A vibration absorber according to claim 9, wherein the wall thickness of the sleeve portion (7) increases from the mass member (3) to the collar portion (8).

13. A vibration absorber according to claim 3, wherein the collar portion (8) of the fixing sleeve (5) comprises a continuous annular groove (11) for receiving a clamp band (12).

14. A vibration absorber according to claim 1, wherein the supporting elements (4), in the axial direction, extend along only a portion of the length of the mass member (3).

15. A vibration absorber according to claim 14, wherein the supporting elements (4) are connected to the mass member (3) axially opposite the fixing sleeve (5).

16. A vibration absorber according to claim 14, wherein the supporting elements (4) are arranged at an axial distance from an end of the mass member (3) opposite the fixing sleeve (5).

17. A vibration absorber according to claim 15, wherein the supporting elements (4) are arranged at least partially axially outside the length of the mass member (3) and adjoining an end of the mass member (3).

18. A vibration absorber according to claim 1, wherein each of the supporting elements (4) comprise substantially identical cross-sectional shapes.

19. A vibration absorber according to claim 1, wherein the supporting elements (4) are arranged so as to be uniformly circumferentially distributed at equal distances from one another.

20. A vibration absorber according to claim 1, wherein the elastic material of the supporting elements (4) and of the fixing sleeve (5) is rubber.

21. A vibration absorber according to claim 1, wherein the sleeve portion (7) includes openings formed therein.
